(19) United States
(12) Patent Application Publication
(10) Pub. No.: US 2026/0065013 A1
(43) Pub. Date: Mar. 5, 2026

(54) CONTROL APPARATUS, CONTROL METHOD, AND RECORDING MEDIUM

(71) Applicant: CASIO COMPUTER CO., LTD., Tokyo (JP)

(72) Inventors: Kouki MAYUZUMI, Tokyo (JP); Kayoko ONODA, Tokyo (JP)

(73) Assignee: CASIO COMPUTER CO., LTD., Tokyo (JP)

(21) Appl. No.: 19/268,849

(22) Filed: Jul. 14, 2025

(30) Foreign Application Priority Data
Aug. 29, 2024 (JP) 2024-147129

(51) Int. Cl. G06N 3/008

(52) U.S. Cl. CPC G06N 3/008

(57) ABSTRACT

A control apparatus that controls a device includes at least one processor. The at least one processor updates, based on a pseudo-biorhythm including three elements with mutually different cycles, a parameter indicating a pseudo-emotion and represented by a coordinate value on a positioning map including at least a first coordinate axis and a second coordinate axis, and causes the device to execute an action associated with the updated parameter. The updating the parameter includes updating a component of the parameter on the first coordinate axis based on a first element and a second element among the three elements, and updating a component of the parameter on the second coordinate axis based on the first element and a third element among the three elements.

### CROSS-REFERENCE TO RELATED APPLICATIONS

This application is based upon and claims the benefit of priority under 35 USC 119 of Japanese Patent Application No. 2024-147129, filed on Aug. 29, 2024, the entire disclosure of which, including the description, claims, drawings, and abstract, is incorporated herein by reference in its entirety.

### FIELD OF THE INVENTION

The present disclosure relates to a control apparatus, a control method, and a recording medium.

### BACKGROUND OF THE INVENTION

A technique for controlling a device that simulates a living creature such as a pet is known. For example, Unexamined Japanese Patent Application Publication No. 2003-117866 discloses a robot device that determines an inner emotion based on a past operation history, a dialogue history, a degree of likability, a degree of intimacy, and the like and acts according to the inner emotion.

### SUMMARY OF THE INVENTION

A control apparatus according to one example of the present disclosure is a control apparatus that controls a device, and includes at least one processor. The at least one processor updates, based on a pseudo-biorhythm including three elements with mutually different cycles, a parameter indicating a pseudo-emotion and represented by a coordinate value on a positioning map including at least a first coordinate axis and a second coordinate axis, and causes the device to execute an action associated with the updated parameter. The updating the parameter includes updating a component of the parameter on the first coordinate axis based on a first element and a second element among the three elements, and updating a component of the parameter on the second coordinate axis based on the first element and a third element among the three elements.

### BRIEF DESCRIPTION OF DRAWINGS

A more complete understanding of this application can be obtained when the following detailed description is considered in conjunction with the following drawings, in which:

FIG. 1 is a view illustrating an appearance of a robot according to Embodiment 1;

FIG. 2 is a sectional view of the robot according to Embodiment 1 as viewed laterally;

FIG. 3 is a block diagram illustrating a functional configuration of the robot according to Embodiment 1;

FIG. 4 is a diagram illustrating an example of an event table according to Embodiment 1;

FIG. 5 is a diagram illustrating an example of an emotion map according to Embodiment 1;

FIG. 6 is a diagram illustrating an example in which an emotion parameter moves according to an event on the emotion map according to Embodiment 1;

FIG. 7 is a diagram illustrating an example in which the emotion parameter returns to an origin on the emotion map according to Embodiment 1;

FIG. 8 is a diagram illustrating an example of time fluctuation of each element of a biorhythm in the robot according to Embodiment 1;

FIG. 9 is a diagram illustrating an example of a cycle of each element of the biorhythm in the robot according to Embodiment 1;

FIG. 10 is a diagram illustrating an example of time fluctuation of an X-axis component and a Y-axis component of a biorhythmic fluctuation vector in the emotion parameter according to Embodiment 1;

FIG. 11 is a diagram illustrating an example in which the emotion parameter fluctuates based on the biorhythm on the emotion map according to Embodiment 1; and

FIG. 12 is a flowchart illustrating a flow of robot control processing according to Embodiment 1.

### DETAILED DESCRIPTION OF THE INVENTION

Hereinafter, embodiments of the present disclosure are described with reference to drawings. Note that, the same or equivalent parts in the drawings are denoted by the same reference signs. A robot 200 according to Embodiment 1 is a device that simulates a living creature and is capable of expressing various states of the living creature in a pseudo manner. In particular, the robot 200 according to Embodiment 1 is a pet-type robot that has a pseudo-emotion and acts based on the pseudo-emotion.

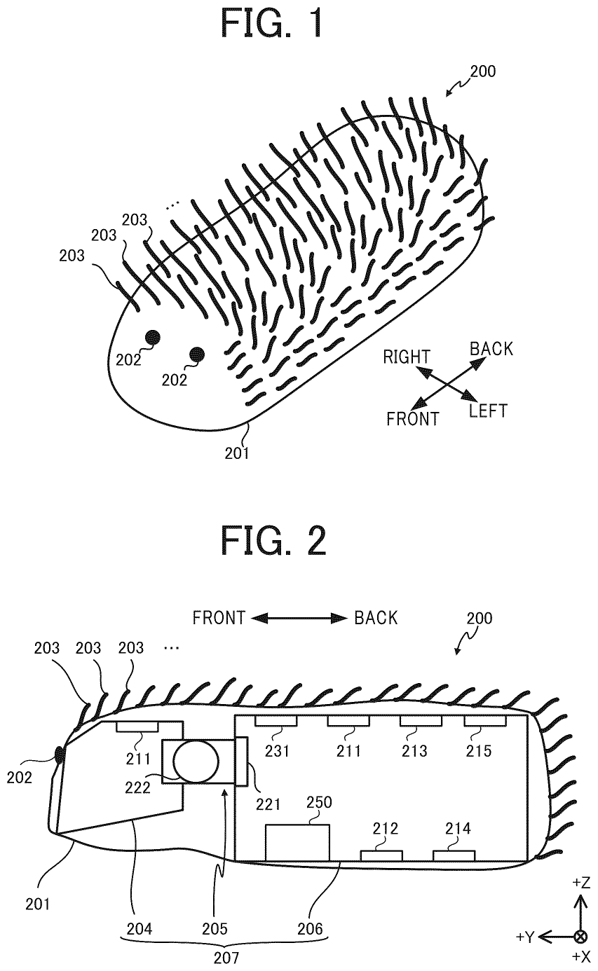

As illustrated in FIG. 1 as one example, the robot 200 according to Embodiment 1 is a pet robot imitating a small animal. The robot 200 includes an exterior 201 that includes decorative parts 202 imitating eyes and bushy hairs 203. As illustrated in FIG. 2, the robot 200 includes a case 207. The case 207 is covered by the exterior 201 and is stored inside the exterior 201. The case 207 includes a head 204, a link 205, and a trunk 206. The link 205 links between the head 204 and the trunk 206.

The exterior 201 is one example of an exterior member, is long in a front-back direction, and has a bag shape capable of housing the case 207 inside. The exterior 201 has a cylindrical shape from the head 204 to the trunk 206, and covers the trunk 206 and the head 204 integrally. By having such a shape of the exterior 201, the robot 200 lies on its belly. The exterior 201 has a shell made of artificial pile fabric imitating the hairs 203 of the small animal in order to simulate a texture of the small animal. The exterior 201 has a lining made of flexible material such as leather, resin, or rubber. Because of the flexible material, the exterior 201 follows movement of the case 207. Specifically, the exterior 201 follows rotation of the head 204 relative to the trunk 206.

The trunk 206 extends in the front-back direction, and makes contact through the exterior 201 with a placing surface such as a floor or a table on which the robot 200 is placed. The trunk 206 includes a twist motor 221 at a front end thereof. The head 204 is linked to the front end of the trunk 206 through the link 205. The link 205 includes an up/down motor 222. Note that, the twist motor 221 is included in the trunk 206 in FIG. 2, but may be included in the link 205. Owing to the twist motor 221 and the up/down motor 222, the head 204 is linked to the trunk 206 in a rotatable manner with a left-right direction (X-axis direction) and the front-back direction (Y-axis direction) of the robot 200 as axes.

The link 205 links between the trunk 206 and the head 204 in a freely rotating manner about a first rotation axis that extends through the link 205 in the front-back direction (Y-axis direction) of the trunk 206. The twist motor 221 is a servomotor for rotating (normally rotating) the head 204 clockwise (right-handedly) or rotating (reversely rotating) the head 204 counter-clockwise (left-handedly) relative to the trunk 206 about the first rotation axis. Further, the link 205 links between the trunk 206 and the head 204 in a freely rotating manner about a second rotation axis that extends through the link 205 in the left-right direction (X-axis direction) of the trunk 206. The up/down motor 222 is a servomotor for rotating (normally rotating) the head 204 upward or rotating (reversely rotating) the head 204 downward about the second rotation axis.

The robot 200 includes touch sensors 211 on the head 204 and the trunk 206. Further, the robot 200 includes, on the trunk 206, an acceleration sensor 212, a microphone 213, a gyro sensor 214, an illuminance sensor 215, a speaker 231, a battery 250, and a communicator 260. Note that, at least a part of the acceleration sensor 212, the microphone 213, the gyro sensor 214, the illuminance sensor 215, and the speaker 231 may be included in the head 204 not limitedly in the trunk 206, or may be included in both of the trunk 206 and the head 204.

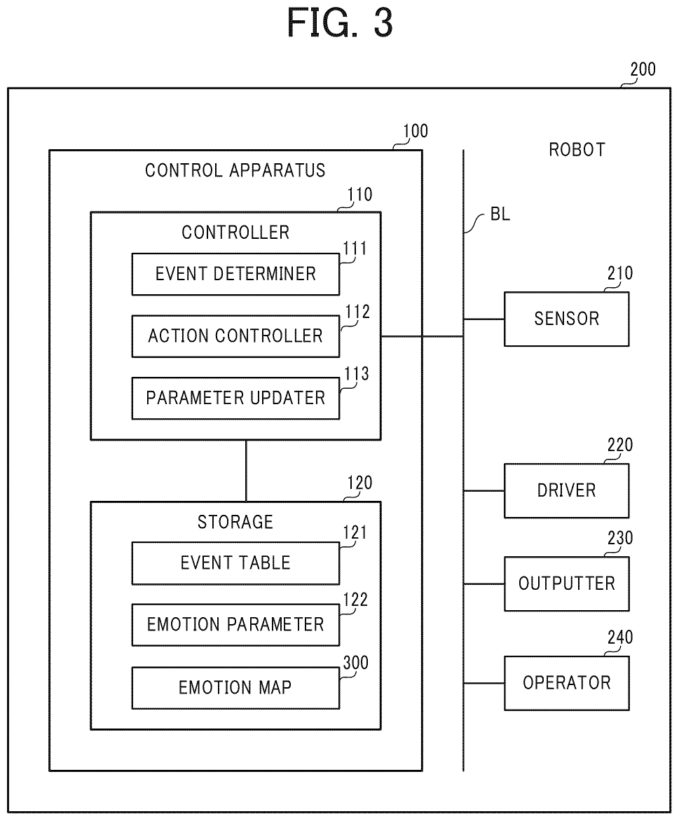

Next, a functional configuration of the robot 200 is described with reference to FIG. 3. As illustrated in FIG. 3, the robot 200 includes a control apparatus 100, a sensor 210, a driver 220, an outputter 230, and an operator 240. As one example, these components are connected via a bus line BL. Note that, instead of the bus line BL, a wired interface such as a universal serial bus (USB) cable or a wireless interface such as Bluetooth (registered trademark) may be used.

The control apparatus 100 includes a controller 110 and a storage 120. The control apparatus 100 is one example of a control apparatus that controls the robot 200 that is a device to be controlled. The control apparatus 100 controls an action of the robot 200 by using the controller 110 and the storage 120. The controller 110 includes a central processing unit (CPU). The CPU is, for example, a microprocessor or the like, and is a central processing unit that executes various types of processing and arithmetic operations. In the controller 110, the CPU reads a control program stored in a ROM and controls an action of the entire own device (robot 200) while using a RAM as a work memory. Further, although not illustrated, the controller 110 includes a clock function, a timer function, and the like, and can clock date and time. The controller 110 may be called a “processor”.

The storage 120 includes a read-only memory (ROM), a random access memory (RAM), a flash memory, and the like. The storage 120 stores a program and data that are used by the controller 110 to perform various types of processing, including an operating system (OS) and an application program. Further, the storage 120 stores data generated or acquired by the controller 110 performing various types of processing. Specifically, the storage 120 stores an event table 121, an emotion parameter 122, and an emotion map 300. Details thereof are described later.

The sensor 210 includes the touch sensor 211, the acceleration sensor 212, the microphone 213, the gyro sensor 214, and the illuminance sensor 215 described above. The controller 110 acquires, via the bus line BL, detection values detected by the sensors of various types included in the sensor 210. Note that, the sensor 210 may include a sensor other than the above. By increasing the type of sensors included in the sensor 210, the type of external stimuli that can be acquired by the controller 110 can be increased. The sensor 210 is one example of an external stimulus detector that detects an external stimulus.

The touch sensor 211 includes, for example, a pressure sensor or a capacitive sensor, and detects presence or absence of a contact made by some object and strength of the contact. The controller 110 can detect, based on a detection value of the touch sensor 211, that a user has patted or slapped on the head 204 or the trunk 206. The acceleration sensor 212 detects an acceleration applied to the trunk 206 of the robot 200. The gyro sensor 214 detects an angular velocity applied to the trunk 206 of the robot 200. The controller 110 can detect a current pose and a pose change of the robot 200 by using the acceleration sensor 212 and the gyro sensor 214. Further, the controller 110 can detect that the robot 200 has been lifted up, turned around, or thrown by a user by using the acceleration sensor 212 and the gyro sensor 214.

The microphone 213 detects a sound around the robot 200. For example, the controller 110 detects, based on a component of a sound detected by the microphone 213, for example, human voice such as user talk to the robot 200. Further, the controller 110 detects, based on a component of a sound detected by the microphone 213, voice other than human voice. The voice other than human voice is, for example, a sound of user clapping hands, an ambient sound or a sudden sound generated around the robot 200, or the like. The illuminance sensor 215 detects an illuminance around the robot 200. The controller 110 can detect, based on an illuminance detected by the illuminance sensor 215, that it has become brighter or darker around the robot 200.

The driver 220 includes the twist motor 221 and the up/down motor 222 described above, and is driven by the controller 110. The robot 200 can express an action of laterally twisting the head 204 by the twist motor 221, and can express an action of raising or lowering the head 204 by the up/down motor 222. The outputter 230 includes the speaker 231, and the controller 110 inputs sound data to the outputter 230, thereby causing the speaker 231 to output a sound. For example, the controller 110 inputs vocal sound data of the robot 200 to the outputter 230, thereby causing the robot 200 to utter a pseudo-vocal sound. Note that, as the outputter 230, a display, a light emitting diode (LED), and the like may be included instead of or in addition to the speaker 231. The operator 240 includes an operation button, a volume knob, and the like. The operator 240 is an interface for accepting a user operation such as, for example, power on/off, volume control of an output sound, or the like. The battery 250 stores electricity for use in the robot 200. The battery 250 is charged by a charging station in a case where the robot 200 comes back home to the charging station.

Next, a functional configuration of the controller 110 is described. As illustrated in FIG. 3, the controller 110 functionally includes an event determiner 111 that is one example of event determination means, an action controller 112 that is one example of action control means, and a parameter updater 113 that is one example of parameter update means. In the controller 110, the CPU reads a program stored in the ROM into the RAM and executes and controls the program, thereby functioning as these components.

The event determiner 111 determines whether an event based on an external stimulus detected by the sensor 210 has occurred. Herein, the external stimulus is a stimulus acting on the robot 200 from outside of the robot 200. The external stimulus is, specifically, a contact detected by the touch sensor 211, an acceleration detected by the acceleration sensor 212, a sound detected by the microphone 213, an angular velocity detected by the gyro sensor 214, an illuminance detected by the illuminance sensor 215, or a combination thereof.

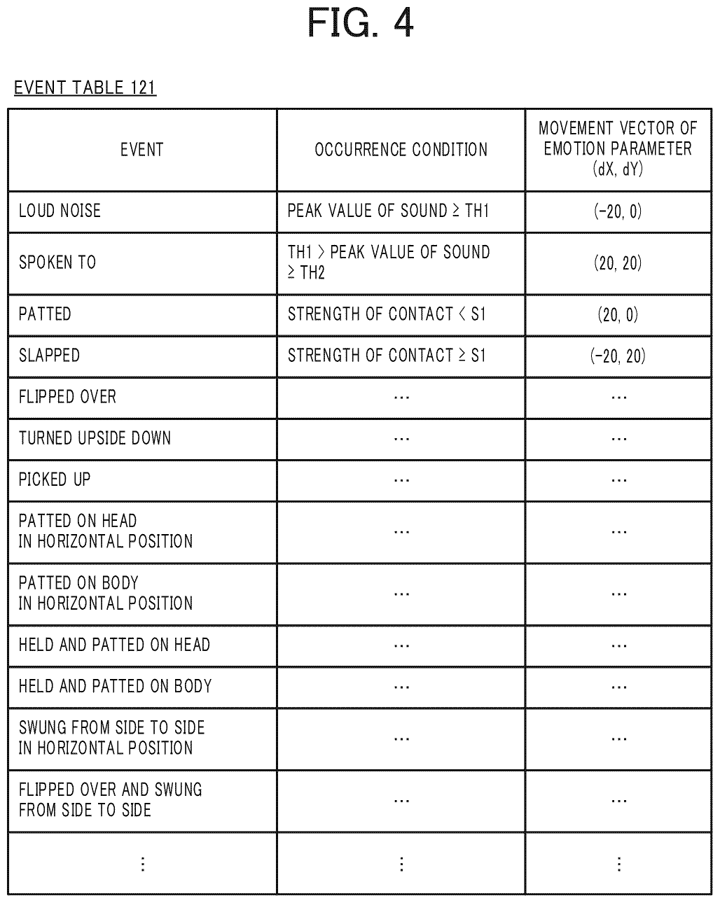

The event determiner 111 determines, based on detection values of the touch sensor 211, the acceleration sensor 212, the microphone 213, the gyro sensor 214, and the illuminance sensor 215 in the sensor 210, whether any of a plurality of events defined in the event table 121 has occurred. The event table 121 is a table that defines a plurality of events that may occur in the robot 200 and establishment conditions for the events. As illustrated in FIG. 4 as one example, the event table 121 defines events such as “loud noise”, “spoken to”, “patted”, “slapped”, and “flipped over”.

The event determiner 111 refers to the event table 121 and determines whether a detection value of an external stimulus detected by the sensor 210 satisfies an occurrence condition for any of the events. For example, the event determiner 111 determines that an event of “loud noise” has occurred in a case where a sound having a peak value greater than or equal to a first threshold value TH1 is detected by the microphone 213. The event determiner 111 determines that an event of “spoken to” has occurred in a case where a sound having a peak value less than the first threshold value TH1 and greater than or equal to a second threshold value TH2 is detected by the microphone 213. The event determiner 111 determines that an event of “patted” has occurred in a case where a contact less than a predetermined strength S1 is detected by the touch sensor 211 of the head 204 or the trunk 206. The event determiner 111 determines that an event of “slapped” has occurred in a case where a contact greater than or equal to the predetermined strength S1 is detected by the touch sensor 211 of the head 204 or the trunk 206. Note that, occurrence conditions for other events are not described in the event table 121 in FIG. 4.

Note that, an occurrence condition may be defined by not only a detection value of a single sensor, but also a combination of detection values of a plurality of sensors in the sensor 210. For example, “patted on the head in a horizontal position” is defined by detection values of the touch sensor 211 of the head 204, the acceleration sensor 212, and the gyro sensor 214. In this way, the event determiner 111 determines, based on an external stimulus detected by the sensor 210, whether an occurrence condition for any of the events defined in the event table 121 is established and, in a case where an occurrence condition for any of the events is established, determines that the event has occurred.

The action controller 112 controls an action of the robot 200. Herein, the action of the robot 200 is achieved by one or both of a motion by the driver 220 and an output by the outputter 230. Specifically, the motion by the driver 220 is equivalent to rotating the head 204 by driving the twist motor 221 or the up/down motor 222. Further, the output by the outputter 230 is equivalent to outputting a vocal sound from the speaker 231 or causing an LED to emit light. The action of the robot 200 may be called a gesture, a behavior, or the like of the robot 200.

Upon detection of an external stimulus by the sensor 210, the action controller 112 causes the robot 200 to act according to the detected external stimulus. More specifically, upon determination by the event determiner 111 that any of the events has occurred, the action controller 112 causes the robot 200 to execute an event action corresponding to the event that has occurred. For example, in a case of “loud noise”, the action controller 112 causes the robot 200 to execute a surprised action. In a case of “spoken to”, the action controller 112 causes the robot 200 to execute an action responding to being spoken to. In a case of “flipped over”, the action controller 112 causes the robot 200 to execute an action indicating a displeased response. In a case of “patted”, the action controller 112 causes the robot 200 to execute a delighted action. In a case of “slapped”, the action controller 112 causes the robot 200 to execute a sad action.

A correspondence relationship between an event and an event action is stored, although not illustrated, in the storage 120 in advance as an action table. As an event action, the action table defines, for each event, a rotation amount and a rotation direction by the twist motor 221, a rotation amount and a rotation direction by the up/down motor 222, and a type of a vocal sound output from the speaker 231 and an output volume thereof. The action controller 112 refers to the action table and causes the robot 200 to execute an event action corresponding to an event that has occurred.

In a case where the event determiner 111 determines that no event has occurred, the action controller 112 causes the robot 200 to execute a spontaneous action at a timing, for example, once every few seconds. Herein, the spontaneous action means an action spontaneously performed by the robot 200 independently of an external stimulus and an event. The action controller 112 causes the robot 200 to execute a breathing action simulating breathing as a spontaneous action. Alternatively, as a spontaneous action, the action controller 112 may randomly drive the twist motor 221 or the up/down motor 222, or may output a random vocal sound from the speaker 231, without limitation to a breathing action.

Returning to FIG. 3, the parameter updater 113 updates the emotion parameter 122. The emotion parameter 122 is a parameter indicating a pseudo-emotion of the robot 200. The emotion parameter 122 is set for the robot 200 to express a degree of appearance of the pseudo-emotion in order that the robot 200 can simulate an action of a living creature. The robot 200 acts according to the emotion parameter 122.

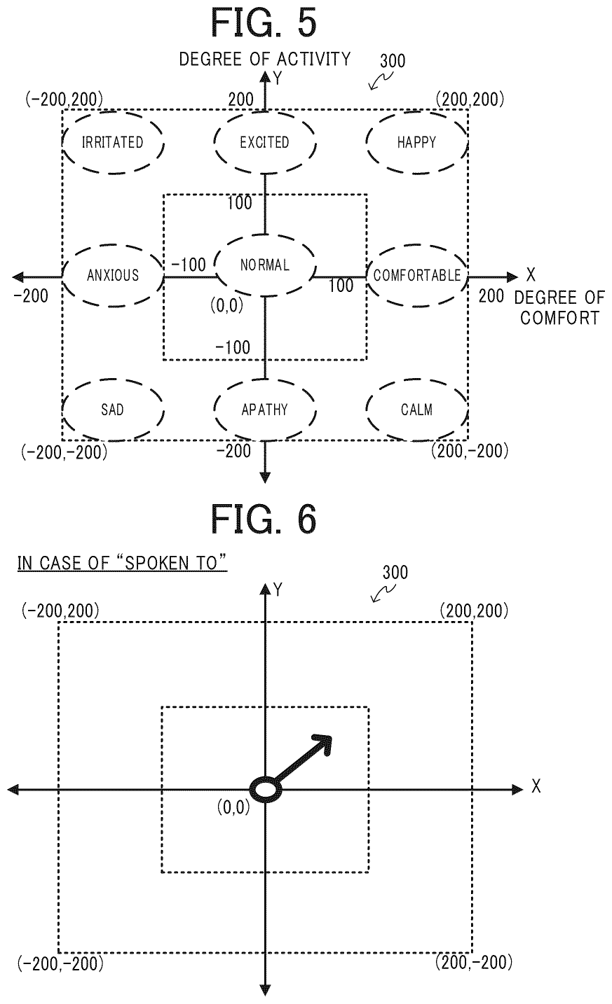

More specifically, the emotion parameter 122 is represented by a position on a positioning map that includes at least two coordinate axes. The positioning map is a map representing a position by a coordinate value based on at least two coordinate axes, such as (X, Y), (X, Y, Z), or the like. Hereinafter, one example of the positioning map is described by using the emotion map 300 illustrated in FIG. 5.

As one example, the emotion map 300 is represented by a two-dimensional coordinate system as illustrated in FIG. 5, and includes an X axis that is a first coordinate axis for representing a pseudo-degree of comfort and a Y axis that is a second coordinate axis for representing a pseudo-degree of activity. A larger absolute value of a positive X-coordinate value (X value) represents an emotion of a higher degree of comfort, and a larger absolute value of a positive Y-coordinate value (Y value) represents an emotion of a higher degree of excitement. Further, a larger absolute value of a negative X value represents an emotion of a higher degree of anxiety, and a larger absolute value of a negative Y value represents an emotion of a higher degree of apathy.

The emotion parameter 122 is represented by a coordinate value (X, Y) that is a position on the emotion map 300, by using such an X value representing a degree of comfort and a degree of anxiety and such a Y value representing a degree of excitement and a degree of apathy. For example, in a case where both of the X value and the Y value are positive and large, the emotion parameter 122 represents an emotion of “happiness”. In a case where the X value is negative and large and the Y value is positive and large, the emotion parameter 122 represents an emotion of “irritation”. In a case where both of the X value and the Y value are negative and large, the emotion parameter 122 represents an emotion of “sadness”. In a case where the X value is positive and large and the Y value is negative and large, the emotion parameter 122 represents an emotion of “calm”. An origin (0, 0) on the emotion map 300 represents a normal emotion. An initial value of the emotion parameter 122 is the origin (0, 0). The parameter updater 113 updates the emotion parameter 122 by moving such a position of the emotion parameter 122 on the emotion map 300.

More specifically, the parameter updater 113 updates the emotion parameter 122 according to an external stimulus detected by the sensor 210. To be more specific, in a case where the event determiner 111 determines, based on an external stimulus detected by the sensor 210, that any of the events defined in the event table 121 has occurred, the parameter updater 113 moves the position of the emotion parameter 122 on the emotion map 300 according to a type of the event that has occurred.

For example, in a case where the event determiner 111 determines that an event of “spoken to” has occurred, the parameter updater 113 moves the emotion parameter 122 to upper right on the emotion map 300, as illustrated in FIG. 6. Thereby, an emotion of happiness increases. Alternatively, although not illustrated, in a case where the event determiner 111 determines that an event of “loud noise” has occurred, the parameter updater 113 moves the emotion parameter 122 to left on the emotion map 300. Thereby, an emotion of anxiety increases.

The event table 121 illustrated in FIG. 4 defines a movement vector (dX, dY) of the emotion parameter 122 on the emotion map 300 for each of a plurality of events that may occur. dX and dY represent movement amounts of the emotion parameter 122 in an X-axis direction and a Y-axis direction of the emotion map 300, respectively. Upon determination by the event determiner 111 that any of the events has occurred, the parameter updater 113 reads a movement vector dX, dY corresponding to the event in the event table 121. Then, the parameter updater 113 moves the position of the emotion parameter 122 on the emotion map 300 according to the read movement vector (dX, dY).

To be more specific, the parameter updater 113 moves the position of the emotion parameter 122 on the emotion map 300 to a coordinate value (Xnext, Ynext) obtained by adding the movement vector (dX, dY) to a current coordinate value (Xcur, Ycur) of the emotion parameter 122, according to an equation (1) below. In this way, in response to an event based on an external stimulus having occurred, the parameter updater 113 updates the emotion parameter 122 according to the event that has occurred. Thereby, emotional changes seen in a real living creature upon experiencing a variety of events can be expressed realistically.

$$( Xnext , Ynext ) = ( Xcur , Ycur ) + ( dX , dY ) \qquad ( 1 )$$

In addition to updating the emotion parameter 122 according to an event in this way, the parameter updater 113 updates the emotion parameter 122 over time even in response to no event having occurred. To be more specific, every time a predetermined time Δt elapses, the parameter updater 113 calculates the coordinate value (Xnext, Ynext) at a movement destination from the current coordinate value (Xcur, Ycur) according to an equation (2) below. Then, the parameter updater 113 moves the position of the emotion parameter 122 on the emotion map 300 to a position of the calculated coordinate value (Xnext, Ynext) at the movement destination. The predetermined time Δt is a time determined in advance such as, for example, one minute or thirty seconds.

$$( Xnext , Ynext ) = ( Xcur , Ycur ) + \{ ( Txcur , Tycur ) - ( Txpre , Typre ) \} \qquad ( 2 )$$

In the above equation (2), (Txcur, Tycur) represents a change vector (Tx, Ty) at a current timing of the emotion parameter 122 over time. Further, (Txpre, Typre) represents a change vector (Tx, Ty) at a timing a predetermined time Δt earlier than the current timing of the emotion parameter 122 over time. The parameter updater 113 calculates the change vector (Tx, Ty) for every predetermined time Δt according to an equation (3) below.

$$( Tx , Ty ) = ( Bx , By ) + H \times ( Cx , Cy ) \qquad ( 3 )$$

(Bx, By) in the above equation (3) represents a return-to-origin vector that causes the emotion parameter 122 to return to the origin (0, 0) that is a reference position on the emotion map 300. The return-to-origin vector (Bx, By) undertakes a role of causing the emotion parameter 122 to return to the origin (0, 0) gradually over time after the emotion parameter 122 moves to a position other than the origin on the emotion map 300 due to occurrence of an event. To be more specific, in a case where the current coordinate value (Xcur, Ycur) of the emotion parameter 122 is other than the origin (0, 0), the return-to-origin vector (Bx, By) is a vector proportional to (−Xcur, −Ycur). In contrast, in a case where the current coordinate value (Xcur, Ycur) of the emotion parameter 122 is the origin (0, 0), the return-to-origin vector (Bx, By) is (0, 0), that is, a 0 vector.

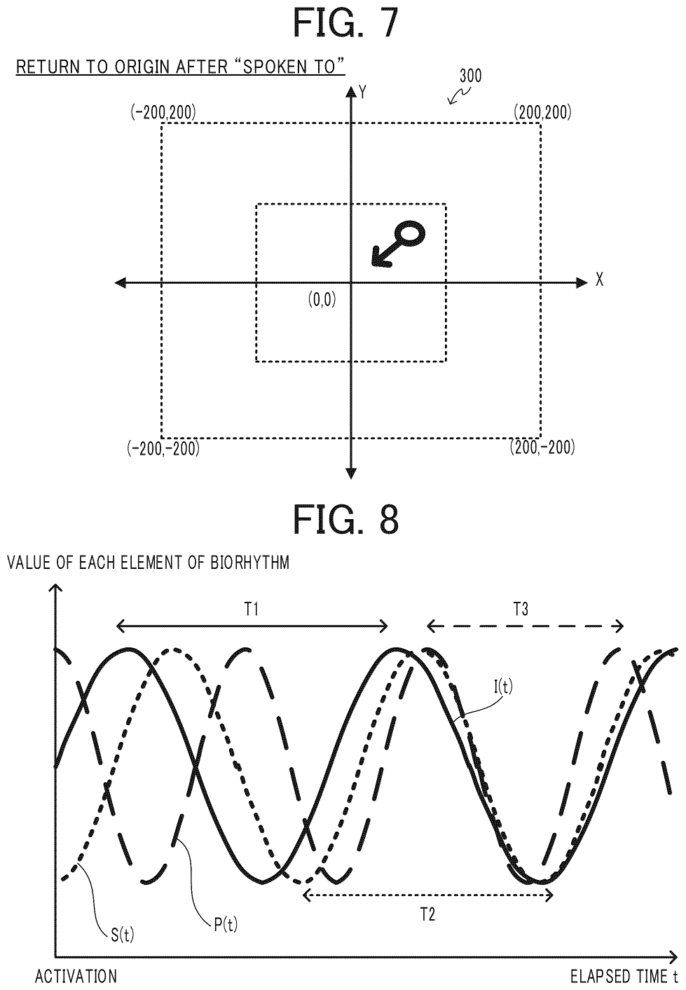

As one example, FIG. 7 illustrates movement of the emotion parameter 122 after an event of “spoken to” has occurred. The emotion parameter 122 moves to upper right from the origin (0, 0) due to an event of “spoken to”, thereafter gradually moves toward the origin (0, 0) by the return-to-origin vector (Bx, By) until a next event occurs, and returns to the origin (0, 0). The parameter updater 113 updates the emotion parameter 122 according to an event, and thereafter causes the position of the emotion parameter 122 on the emotion map 300 to approach the origin (0, 0) that is a reference position by such a return-to-origin vector (Bx, By) over time until a next event occurs. Thereby, the pseudo-emotion of the robot 200 gradually returns to normal while no event has occurred.

Next, (Cx, Cy) in the above equation (3) represents a biorhythmic fluctuation vector of the emotion parameter 122. Herein, the biorhythm means a rhythm seen in physical and mental states of a living creature, that is, a cyclic fluctuation pattern. The fluctuation vector (Cx, Cy) is a term for allowing the emotion parameter 122 to waver even in a case where no event has occurred. In a case where there is no term of the fluctuation vector (Cx, Cy) in the above equation (3), the emotion parameter 122 does not move at all from the origin (0, 0) while no event has occurred. In other words, the emotion parameter 122 does not change at all while a user leaves the robot 200 unattended for a long time without any interaction with the robot 200. This is unnatural in a real living creature, and leads to reduction in creature-likeness.

In order to avoid this, the parameter updater 113 simulates a biorhythm seen in a real living creature also in the robot 200, and updates the emotion parameter 122 based on a pseudo-biorhythm (hereinafter, referred to simply as a “biorhythm”). To be more specific, by introducing the biorhythmic fluctuation vector (Cx, Cy), the parameter updater 113 causes the emotion parameter 122 to waver over time even in a case where no event has occurred. Thereby, natural emotions of a real living creature are expressed in a pseudo manner and creature-likeness is increased.

Hereinafter, the biorhythm is described in more detail. The biorhythm includes three elements (may be called “components”) that are cycle patterns with mutually different cycles. A first element of the biorhythm is an element (intellectual rhythm) relating to intellectual (intelligence) of the biorhythm. A second element of the biorhythm is an element (emotional rhythm) relating to sensitivity (emotion) of the biorhythm. A third element in the biorhythm is an element (physical rhythm) relating to physical (body) of the biorhythm.

As illustrated in FIG. 8, a pattern of time fluctuation of each element of the biorhythm is represented as a sine wave. FIG. 8 illustrates elapsed time t from an activation timing of the robot 200 on a horizontal axis, and illustrates values of the intellectual rhythm (solid line), the emotional rhythm (dotted line), and the physical rhythm (dashed line) that are the three elements of the biorhythm on a vertical axis. More specifically, the values of the three elements of the biorhythm are represented as equations (4A) to (4C) below by using a trigonometric function sin( ). Note that, in the equations (4A) to (4C), T1 to T3 represent a cycle of each element and φ1 to φ3 represent an initial phase value of each element.

$$Intellectual rhythm ( first element ) : I ( t ) = sin ( 2 π t / T 1 + φ1 ) \qquad ( 4 A )$$

$$Emotional rhythm ( second element ) : S ( t ) = sin ( 2 πt / T 2 + φ2 ) \qquad ( 4 B )$$

$$Physical rhythm ( third element ) : P ( t ) = sin ( 2 π t / T 3 + φ3 ) \qquad ( 4 C )$$

The cycles T1 to T3 of the sine waves of the three elements I(t), S(t), and P(t) of the biorhythm are set to be different from one another. Specifically, the cycle T1 of the first element T(t) that is the intellectual rhythm is longer than the cycle T2 of the second element S(t) that is the emotional rhythm and is longer than the cycle T3 of the third element P(t) that is the physical rhythm. Further, the cycle T2 of the second element S(t) is longer than the cycle T3 of the third element P(t).

More specifically, as illustrated in FIG. 9, the intellectual rhythm, the emotional rhythm, and the physical rhythm of humans are known to generally fluctuate cyclically in 33-day, 28-day, and 23-day cycles, respectively. Taking this into consideration, values obtained by converting a cycle of the biorhythm in humans to a battery life of the robot 200 are used as the cycles T1 to T3 of the biorhythm in the robot 200. Specifically, assuming that an average life of humans is 70 years and an average battery life of the robot 200 is 2 years, cycles of the elements of the biorhythm in the robot 200 are calculated to be 23 hours, 19 hours, and 16 hours by multiplying the cycle of each element of the biorhythm in humans by “2/70”. Thus, the parameter updater 113 sets the cycles T1 to T3 of the intellectual rhythm, the emotional rhythm, and the physical rhythm of the robot 200 to 23 hours, 19 hours, and 16 hours, respectively.

The parameter updater 113 updates the emotion parameter 122, based on the three elements I(t), S(t), and P(t) of the biorhythm that are cycle patterns fluctuating with such mutually different cycles. To be more specific, the parameter updater 113 updates a component (X-axis component) of the emotion parameter 122 on the first coordinate axis of the emotion map 300, based on the first element I(t) and the second element S(t) among the three elements of the biorhythm. Along with this, the parameter updater 113 updates a component (Y-axis component) of the emotion parameter 122 on the second coordinate axis of the emotion map 300, based on the first element I(t) and the third element P(t) among the three elements of the biorhythm.

More specifically, the parameter updater 113 calculates the biorhythmic fluctuation vector (Cx, Cy) according to an equation (5) below. Specifically, the parameter updater 113 calculates an X-axis component Cx of the fluctuation vector by a product of the first element I(t) and the second element S(t), and calculates a Y-axis component Cy of the fluctuation vector by a product of the first element I(t) and the third element P(t). Note that, K in the equation (5) is a maximum value of an absolute value of Cx and Cy. A value of K is set to 100 as one example.

$$( Cx , Cy ) = ( S ( t ) \times I ( t ) \times K , P ( t ) \times I ( t ) \times K ) \qquad ( 5 )$$

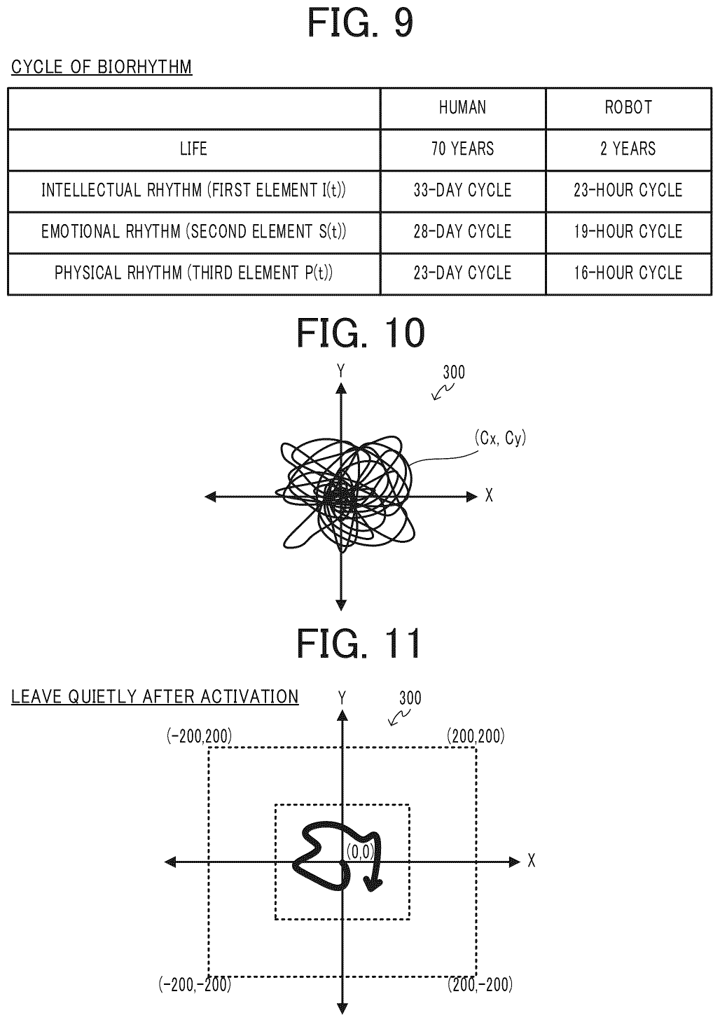

The X-axis component Cx of the fluctuation vector is calculated by a product of the first element I(t) having the cycle T1 and the second element S(t) having the cycle T2, resulting in a pattern that is a superposition of a long cycle pattern having a cycle (T1+T2) and a short cycle pattern having a cycle (T1−T2). Further, the Y-axis component Cy of the fluctuation vector is calculated by a product of the first element I(t) having the cycle T1 and the third element P(t) having the cycle T3, resulting in a pattern that is a superposition of a long cycle pattern having a cycle (T1+T3) and a short cycle pattern having a cycle (T1−T3). In this way, the parameter updater 113 calculates each component of the fluctuation vector (Cx, Cy) by a product of two elements that fluctuate with mutually different cycles, and thereby can create a cyclic but complicated pattern. Specifically, time fluctuation of the biorhythmic fluctuation vector (Cx, Cy) expressed on the emotion map 300 is a difficult-to-predict and complicated movement, as in, for example, FIG. 10.

Due to such a biorhythmic fluctuation vector (Cx, Cy), the emotion parameter 122 in a case where no event has occurred moves in a wavering manner around the origin (0, 0) on the emotion map 300, as illustrated in FIG. 11. In a case where there is no biorhythmic fluctuation vector (Cx, Cy), the emotion parameter 122 does not change at all unless an event occurs, leading to reduction in creature-likeness. In contrast, in Embodiment 1, there is a term of the biorhythmic fluctuation vector (Cx, Cy) in the change vector (Tx, Ty) of the emotion parameter 122, as in the above equation (3). Thereby, the emotion parameter 122 wavers over time as illustrated in FIG. 11, so that natural emotional changes in a living creature can be simulated realistically.

Note that, the parameter updater 113 randomly sets the initial phase values φ1 to φ3 of the three elements of the biorhythm indicated in the above equations (4A) to (4C) every time the robot 200 is activated. Herein, the initial phase value of each element is equivalent to a fluctuation start position of a sinusoidal pattern of each element at a time of activation of the robot 200. Further, the activation of the robot 200 means that the robot 200 starts normal operation upon power-on of the robot 200 or the like.

In a case where the initial phase values φ1 to φ3 are set the same every time the robot 200 is activated, movement of the emotion parameter 122 at a time of activation is the same every time, leading to a sense of repetitiveness to a user. In order to avoid this, the parameter updater 113 sets each of the initial phase values φ1 to φ3 randomly by using a random number every time the robot 200 is activated. As a result, the values of the elements of the biorhythm start cyclic fluctuations at mutually different initial values from an activation timing of the robot 200, as illustrated in, for example, FIG. 8. Furthermore, the elements of the biorhythm start from different values every time the robot 200 is activated. Thus, the behavior of the robot 200 becomes less predictable and creature-likeness of the robot 200 can be further improved.

Returning to the above equation (3), a coefficient H in the above equation (3) is a coefficient to be multiplied on the biorhythmic fluctuation vector (Cx, Cy). The coefficient H is set to gradually increase over time in a case where no event based on an external stimulus has occurred in the robot 200. By using such a coefficient H, the parameter updater 113 increases a fluctuation amount of the emotion parameter 122 based on the biorhythm over time in response to no event having occurred.

To be more specific, while the event determiner 111 determines that none of the events defined in the event table 121 has occurred, the parameter updater 113 increases the value of the coefficient H by 0.1 per minute from an initial value 0.1 to a maximum value 1. Further, in a case where the event determiner 111 determines that any of a plurality of events defined in the event table 121 has occurred, the parameter updater 113 returns the value of the coefficient H to the initial value 0.1.

In this way, the parameter updater 113 increases the coefficient H to be multiplied on the biorhythmic fluctuation vector (Cx, Cy) gradually over time until a next event occurs after a last event has occurred. Thereby, in a case where a user leaves the robot 200 unattended, a fluctuation amount of both of the X-axis component and the Y-axis component of the emotion parameter 122 gradually increases over time as the time left unattended increases, and a wavering movement of the emotion parameter 122 on the emotion map 300 gradually increases. By such a movement of the emotion parameter 122, it becomes possible to more realistically express natural emotional changes of a living creature, such as increased emotions of loneliness, boredom, and the like caused by being left unattended.

The return-to-origin vector (Bx, By), the biorhythmic fluctuation vector (Cx, Cy), and the coefficient H are calculated in this way, and then the parameter updater 113 calculates the change vector (Tx, Ty) according to the above equation (3). The change vector (Tx, Ty) is calculated, and then the parameter updater 113 sets the newly calculated change vector (Tx, Ty) as (Txcur, Tycur) and the change vector (Tx, Ty) calculated a predetermined time Δt earlier than the current time as (Txpre, Typre), and calculates a difference therebetween. Then, the parameter updater 113 adds the calculated difference to the current coordinate value (Xcur, Ycur) according to the above equation (2), and thereby calculates the coordinate value (Xnext, Ynext) at the movement destination and moves the position of the emotion parameter 122 to the coordinate value (Xnext, Ynext) at the movement destination.

The parameter updater 113 updates the emotion parameter 122 according to the above equation (1) or the above equation (2) as described above, and then the action controller 112 causes the robot 200 to act based on the emotion parameter 122 updated by the parameter updater 113. For example, in a case where the emotion parameter 122 represents “happiness”, the action controller 112 causes the robot 200 to execute a motion that appears to be happy by the driver 220, and, in a case where the emotion parameter 122 represents “sadness”, the action controller 112 causes the robot 200 to execute a motion that appears to be sad by the driver 220. Alternatively, in a case where the emotion parameter 122 represents “happiness”, the action controller 112 causes the outputter 230 to output a vocal sound that sounds happy, and, in a case where the emotion parameter 122 represents “sadness”, the action controller 112 causes the outputter 230 to output a vocal sound that sounds sad.

More specifically, the action controller 112 causes the robot 200 to execute an emotional action corresponding to the current position of the emotion parameter 122 on the emotion map 300. For example, the emotion map 300 is divided into N×N areas. Then, the action controller 112 causes the robot 200 to execute, as an emotional action, an action corresponding to an area where the emotion parameter 122 is positioned among the N×N areas.

In a case where an event has occurred, the action controller 112 may cause the robot 200 to execute such an emotional action together with an event action corresponding to the event that has occurred, or, in a case where no event has occurred, the action controller 112 may cause the robot 200 to execute such an emotional action together with a spontaneous action. Alternatively, the action controller 112 may cause the robot 200 to execute an emotional action as an independent action at a timing independently of an event action or a spontaneous action. By causing the robot 200 to execute such an emotional action, a user can check what kind of emotion the robot 200 currently has. In particular, the user can check how the emotion of the robot 200 fluctuates according to the biorhythm, leading to a greater sense of attachment to the robot 200.

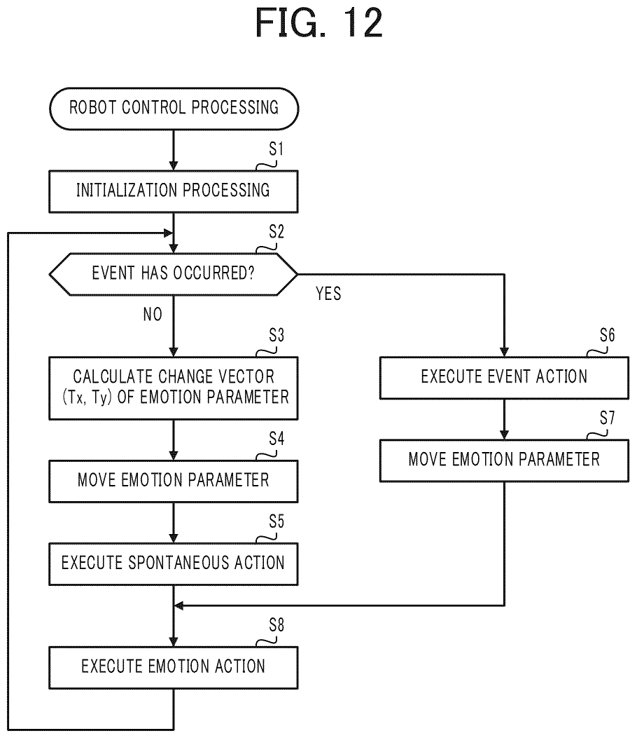

Next, a flow of robot control processing according to Embodiment 1 is described with reference to FIG. 12. The robot control processing illustrated in FIG. 12 is executed by the controller 110 of the control apparatus 100 in response to power-on of the robot 200. The robot control processing illustrated in FIG. 12 is one example of a robot control method.

Once the robot control processing is started, the controller 110 executes initialization processing (Step S1). In the initialization processing, the controller 110 sets the position of the emotion parameter 122 on the emotion map 300 to the origin. Further, in the initialization processing, the controller 110 sets the initial phase values φ1, φ2, and φ3 of the three elements of the biorhythm randomly by using random numbers.

Once the initialization processing is executed, the controller 110 functions as the event determiner 111 and determines whether an event has occurred (Step S2). To be more specific, the controller 110 determines, based on a detection value of an external stimulus detected by the sensor 210, whether an occurrence condition for an event of any type defined in the event table 121 is established.

In a case where no event has occurred (Step S2; NO), the controller 110 calculates the change vector (Tx, Ty) of the emotion parameter 122 over time for each predetermined time Δt (Step S3). To be more specific, the controller 110 calculates a return-to-origin vector (Bx, By) based on the current coordinate value (Xcur, Ycur) of the emotion parameter 122. Further, the controller 110 calculates the biorhythmic fluctuation vector (Cx, Cy) according to the above-described equation (5). In addition, the controller 110 calculates the coefficient H so as to be larger as the time elapsed from determination that the last event has occurred in Step S2 increases. Then, the controller 110 calculates the change vector (Tx, Ty) according to the above-described equation (3) by using the calculated return-to-origin vector (Bx, By), the fluctuation vector (Cx, Cy), and the coefficient H.

Once the change vector (Tx, Ty) of the emotion parameter 122 is calculated, the controller 110 functions as the parameter updater 113 and moves the emotion parameter 122 on the emotion map 300 (Step S4). To be more specific, the controller 110 calculates the coordinate value (Xnext, Ynext) at the movement destination according to the above-described equation (2) by using the current change vector (Txcur, Tycur) and the change vector (Txpre, Typre) a predetermined time Δt earlier than the current time. Then, the controller 110 moves the position of the emotion parameter 122 on the emotion map 300 to the position of the coordinate value (Xnext, Ynext) at the movement destination. Further, once a timing for a spontaneous action arrives, the controller 110 functions as the action controller 112 and causes the robot 200 to execute the spontaneous action (Step S5).

Meanwhile, in a case where an event has occurred in Step S2 (Step S2; YES), the controller 110 functions as the action controller 112 and causes the robot 200 to execute an event action corresponding to the event that has occurred (Step S6). Next, the controller 110 functions as the parameter updater 113 and moves the emotion parameter 122 on the emotion map 300 according to the event that has occurred (Step S7). To be more specific, the controller 110 reads the movement vector (dX, dY) corresponding to the event that has occurred from the event table 121. Then, the controller 110 calculates the coordinate value (Xnext, Ynext) at the movement destination from the current coordinate value (Xcur, Ycur) according to the above-described equation (1), and moves the position of the emotion parameter 122 on the emotion map 300 to the coordinate value (Xnext, Ynext) at the movement destination.

Once the emotion parameter 122 is moved in Step S4 or S7, the controller 110 functions as the action controller 112 and causes the robot 200 to execute an emotional action corresponding to the emotion parameter 122 after movement (Step S8). For example, in a case where the emotion parameter 122 represents “happiness”, the controller 110 causes the robot 200 to execute an action that appears to be happy, and, in a case where the emotion parameter 122 represents “sadness”, the controller 110 causes the robot 200 to execute an action that appears to be sad. Note that, the controller 110 may cause the robot 200 to execute such an emotional action together with a spontaneous action in Step S5 or together with an event action in Step S6. Thereafter, the controller 110 returns the processing to Step S2. In this way, the controller 110 repeatedly executes the processing in Steps S2 to S8 as long as power of the robot 200 is on and the robot 200 is capable of acting normally.

As described above, the control apparatus 100 of the robot 200 according to Embodiment 1 updates, based on a pseudo-biorhythm including three elements with mutually different cycles, the emotion parameter 122 indicating a pseudo-emotion of the robot 200, and causes the robot 200 to act based on the updated emotion parameter 122. In this way, the control apparatus 100 updates the emotion parameter 122 based on the pseudo-biorhythm, so that the emotion parameter 122 can waver even in a case where an event such as an interaction with a user has not occurred. Thus, the robot 200 can be expressed as having independent emotions and creature-likeness of the robot 200 can be improved.

In particular, the control apparatus 100 updates the X-axis component of the emotion parameter 122 based on the first element and the second element of the biorhythm, and updates the Y-axis component of the emotion parameter 122 based on the first element and the third element of the biorhythm. In this way, the control apparatus 100 updates the X-axis component and the Y-axis component of the emotion parameter 122 based on two elements with different cycles of the biorhythm, so that a biorhythm-based and sense-of-repetitiveness-free complicated fluctuation can be expressed. Thus, a wavering movement of natural emotions can be expressed and creature-likeness of the robot 200 can be further improved.

Next, Embodiment 2 is described. Descriptions of configurations and functions similar to Embodiment 1 are omitted as appropriate. In above Embodiment 1, the parameter updater 113 updates the emotion parameter 122 based on a pseudo-biorhythm. In contrast, in Embodiment 2, a parameter updater 113 updates an emotion parameter 122 not based on a biorhythm per se but by using a general cycle pattern simulating a biorhythm.

In Embodiment 2, the parameter updater 113 updates an X-axis component and a Y-axis component of the emotion parameter 122 by using cycle patterns V1(t) to V4(t) that are sinusoidal patterns of cycles irrelevant to the biorhythm, instead of the three elements I(t), S(t), and P(t) of the biorhythm described in Embodiment 1. Specifically, the parameter updater 113 calculates a fluctuation vector (Cx, Cy) according to an equation (5′) below instead of the equation (5). Descriptions other than this are similar to Embodiment 1 and are thus omitted.

$$( Cx , Cy ) = ( V 1 ( t ) \times V 2 ( t ) \times K , V 3 ( t ) \times V 4 ( t ) \times K ) \qquad ( 5 ’ )$$

As in the above equation (5′), the parameter updater 113 updates the X-axis component of the emotion parameter 122 based on a first cycle pattern V1(t) fluctuating with a first cycle U1 and a second cycle patternV2(t) fluctuating with a second cycle U2 different from the first cycle U1. Then, along with this, the parameter updater 113 updates the Y-axis component of the emotion parameter 122 based on a third cycle pattern V3(t) fluctuating with a third cycle U3 and a fourth cycle pattern V4(t) fluctuating with a fourth cycle U4 different from the third cycle U3.

Herein, the cycles U1 to U4 of the cycle patterns V1(t) to V4(t) can be set to cycles irrelevant to the three elements I(t), S(t), and P(t) of the biorhythm. For example, all of the cycles U1 to U4 may be different from one another. Alternatively, one of the cycles U1 and U2 may be the same as one of the cycles U3 and U4, similarly to a case where the first element I(t) is used for both of the X-axis component and the Y-axis component of the emotion parameter 122 in Embodiment 1. However, at least one of the cycles U1 and U2 is set to be different from both of the cycles U3 and U4 in order that the X-axis component and the Y-axis component of the emotion parameter 122 do not become exactly the same.

In this way, in Embodiment 2, the parameter updater 113 updates the emotion parameter 122 based on the general cycle patterns V1(t) to V4(t) different from the biorhythm per se. Use of such general cycle patterns V1(t) to V4(t) also makes it possible to express a wavering movement of natural emotions. Since the general cycle patterns V1(t) to V4(t) can be used, cycles can be set freely, leading to a higher degree of freedom in designing the robot 200.

While the embodiments of the present disclosure have been described above, the above embodiments are examples, and an application range of the present disclosure is not limited thereto. That is, the embodiments of the present disclosure can be applied in various ways, and any embodiments are included in the scope of the present disclosure.

For example, in above Embodiment 1, the parameter updater 113 updates the X-axis component of the emotion parameter 122 based on the first element (intellectual rhythm) and the second element (emotional rhythm) of the biorhythm, and updates the Y-axis component of the emotion parameter 122 based on the first element (intellectual rhythm) and the third element (physical rhythm) of the biorhythm. However, the X-axis component and the Y-axis component of the emotion parameter 122 may be any combination of the three elements of the biorhythm as long as the combination is possible. For example, the first element used for both of the X-axis component and the Y-axis component of the emotion parameter 122 is not limited to the intellectual rhythm having the longest cycle T1 among the three elements of the biorhythm, but the emotional rhythm or the physical rhythm may be used as the first element for both of the X-axis component and the Y-axis component. However, by applying the intellectual rhythm having the longest cycle T1 among the three elements to both of the X-axis component and the Y-axis component, the cycle of the long cycle pattern in both of the X-axis component and the Y-axis component can be extended. Thus, an advantageous effect that a sense of repetitiveness can be reduced as much as possible is obtained.

In above Embodiment 1, the X-axis component and the Y-axis component of the emotion parameter 122 are represented by a product of the first element and the second element and a product of the first element and the third element, respectively. Further, in above Embodiment 2, the X-axis component and the Y-axis component of the emotion parameter 122 are represented by a product of two cycle patterns fluctuating with mutually different cycles. However, the X-axis component and the Y-axis component of the emotion parameter 122 are not limited to such a simple product form, but may be a sum form, a form combining sum and product, or the like.

In the above embodiment, the reference position on the emotion map 300 is the origin (0, 0). However, the reference position is not limited to the origin, but may be any position on the emotion map 300. For example, a personality coefficient representing a pseudo-personality may be set for the robot 200, and the reference position may be a position offset from the origin (0, 0) according to the personality coefficient. Then, the biorhythmic fluctuation vector (Cx, Cy) may fluctuate about the reference position offset from the origin (0, 0) in this way. For example, by adding a term of offset according to the personality coefficient to each component of the fluctuation vector (Cx, Cy) in the above equation (5), such a fluctuation shifted from the origin (0, 0) can be achieved. Thereby, by setting personality coefficients mutually different between a plurality of robots 200, a reference position of an emotional change can be shifted depending on a personality difference between the robots 200, allowing the robots 200 to have individuality.

In the above embodiment, the emotion map 300 includes two coordinate axes, the X axis and the Y axis. However, the emotion map 300 may include three or more coordinate axes. Further, the coordinate axis of the emotion map 300 is not limited to a pseudo-degree of comfort and a pseudo-degree of activity, but may represent a degree of other emotions. In a case where the emotion map 300 includes three or more coordinate axes, the emotion parameter 122 is represented by three or more components. In this case, the parameter updater 113 may update at least two components among the three or more components of the emotion parameter 122 in a manner similar to Embodiment 1 or Embodiment 2.

In the above embodiment, the exterior 201 has a cylindrical shape from the head 204 to the trunk 206, and the robot 200 lies on its belly. However, the robot 200 is not limited to a simulated living creature lying on its belly. For example, the robot 200 may be a simulated quadrupedal or bipedal living creature having a shape with hands and legs.

In the above embodiment, the robot 200 includes the built-in control apparatus 100, but the control apparatus 100 may not be built in the robot 200 but may be a separate apparatus (for example, a server). In a case where the control apparatus 100 is present outside the robot 200, the robot 200 communicates with the control apparatus 100 via a not-illustrated communicator and transmits and receives data to and from each other. Through such a communication with the robot 200, the event determiner 111 determines whether an event has occurred based on an external stimulus detected by the sensor 210, the action controller 112 controls the driver 220 and the outputter 230, and the parameter updater 113 updates the emotion parameter 122.

In the above embodiment, a device to be controlled by the control apparatus 100 is the robot 200. However, a device to be controlled by the control apparatus 100 is not limited to a device that exists in a real world such as the robot 200, but may be a display device that displays, on a screen, an object of a virtual character or the like that exists in a virtual world such as, for example, an avatar. In this case, the display device includes the sensor 210 detecting an external stimulus. Then, in a manner similar to the above embodiment, the control apparatus 100 updates the emotion parameter 200 based on the external stimulus detected by the sensor 210, the pseudo-biorhythm, or the like, and causes the display device to act based on the updated emotion parameter 200. Specifically, the control apparatus 100 moves the object displayed on the screen of the display device, changes a facial expression of the object, and utters a voice from the object based on the emotion parameter 200, thereby causing the object to act like a living creature. In this way, the display device functions as a device that simulates a living creature by causing the object displayed on the screen to act like a living creature. Besides the above, a similar description can be made by replacing the “robot 200” in the above embodiment with “a display device”.

In the above embodiment, the CPU in the controller 110 executes a program stored in the ROM, thereby functioning as each of the event determiner 111, the action controller 112, and the parameter updater 113. However, in the present disclosure, the controller 110 may include, instead of the CPU, dedicated hardware such as, for example, an application specific integrated circuit (ASIC), a field-programmable gate array (FPGA), or various types of control circuits, and the dedicated hardware may function as each of the event determiner 111, the action controller 112, and the parameter updater 113. In this case, each of the functions of the components may be achieved by an individual piece of hardware, or the functions of the components may be collectively achieved by a single piece of hardware. Further, a part of the functions of the components may be achieved by dedicated hardware, and another part may be achieved by software or firmware.

Note that, not only can the robot be provided as a robot preliminarily including the configuration for achieving the function according to the present disclosure, but also an existing information processing device or the like can be made to function as the robot according to the present disclosure by application of a program. That is, by applying a program for achieving the functional configurations of the robot 200 illustrated in the embodiment in such a way that a CPU or the like controlling an existing information processing device or the like can execute the program, the existing information processing device or the like can be made to function as the robot according to the present disclosure.

Further, such a program may be applied by any way. A program can be applied in a way stored in a computer-readable recording medium such as, for example, a flexible disk, a compact disc (CD)-ROM, a digital versatile disc (DVD)-ROM, or a memory card. Furthermore, a program can be superimposed on a carrier and applied via a communication medium such as the Internet. For example, a program may be posted on a bulletin board system (BBS) on a communication network and delivered. Then, the program is started and executed under control of an operating system (OS) in a way similar to other application programs, thereby enabling the above processing to be executed.

While the preferred embodiments or the like of the present disclosure have been described above, the present disclosure is not limited to the above-described embodiments or the like, but the above-described embodiments or the like can be modified and substituted in various ways without departing from the scope of the claims.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A control apparatus that controls a device, the control apparatus comprising:
at least one processor that updates, based on a pseudo-biorhythm including three elements with mutually different cycles, a parameter indicating a pseudo-emotion and represented by a coordinate value on a positioning map including at least a first coordinate axis and a second coordinate axis, and causes the device to execute an action associated with the updated parameter, wherein
the updating the parameter includes updating a component of the parameter on the first coordinate axis based on a first element and a second element among the three elements, and updating a component of the parameter on the second coordinate axis based on the first element and a third element among the three elements.

2. The control apparatus according to claim 1, wherein a cycle of the first element is longer than a cycle of the second element and is longer than a cycle of the third element.

3. The control apparatus according to claim 1, wherein
the first element is an element relating to intellectual of the pseudo-biorhythm,
the second element is an element relating to sensitivity of the pseudo-biorhythm, and
the third element is an element relating to physical of the pseudo-biorhythm.

4. The control apparatus according to claim 1, wherein the at least one processor calculates a component of the parameter on the first coordinate axis by a product of the first element and the second element, and calculates a component of the parameter on the second coordinate axis by a product of the first element and the third element.

5. The control apparatus according to claim 1, wherein the at least one processor randomly sets initial phase values of the three elements every time the device is activated.

6. The control apparatus according to claim 1, wherein, in response to an event based on an external stimulus detected in the device having occurred, the at least one processor updates the parameter based on the event that has occurred.

7. The control apparatus according to claim 6, wherein, in response to the event not having occurred, the at least one processor causes a position of the parameter on the positioning map to approach a reference position over time.

8. The control apparatus according to claim 6, wherein, in response to the event not having occurred, the at least one processor increases a fluctuation amount of the parameter based on the pseudo-biorhythm over time.

9. The control apparatus according to claim 1, wherein the device is a robot simulating a living creature.

10. A control method for controlling a device, comprising:
a parameter update step for updating, based on a pseudo-biorhythm including three elements with mutually different cycles, an parameter indicating a pseudo-emotion; and
an action control step for causing the device to act based on the parameter updated in the parameter update step, wherein
the parameter is represented by a coordinate value on a positioning map including at least a first coordinate axis and a second coordinate axis, and
the parameter update step updates a component of the parameter on the first coordinate axis based on a first element and a second element among the three elements, and updates a component of the parameter on the second coordinate axis based on the first element and a third element among the three elements.

11. The control method according to claim 10, wherein a cycle of the first element is longer than a cycle of the second element and is longer than a cycle of the third element.

12. The control method according to claim 10, wherein
the first element is an element relating to intellectual of the pseudo-biorhythm,
the second element is an element relating to sensitivity of the pseudo-biorhythm, and
the third element is an element relating to physical of the pseudo-biorhythm.

13. The control method according to claim 10, wherein the parameter update step calculates a component of the parameter on the first coordinate axis by a product of the first element and the second element, and calculates a component of the parameter on the second coordinate axis by a product of the first element and the third element.

14. The control method according to claim 10, wherein the parameter update step randomly sets initial phase values of the three elements every time the device is activated.

15. The control method according to claim 10, wherein, in response to an event based on an external stimulus detected in the device having occurred, the parameter update step updates the parameter based on the event that has occurred.

16. The control method according to claim 15, wherein, in response to the event not having occurred, the parameter update step causes a position of the parameter on the positioning map to approach a reference position over time.

17. The control method according to claim 15, wherein, in response to the event not having occurred, the parameter update step increases a fluctuation amount of the parameter based on the pseudo-biorhythm over time.

18. The control method according to claim 10, wherein the device is a robot simulating a living creature.

19. A non-transitory computer-readable recording medium storing a program, the program causing a computer that controls a device to achieve:
a first function of updating, based on a pseudo-biorhythm including three elements with mutually different cycles, an parameter indicating a pseudo-emotion; and
a second function of causing the device to act based on the parameter updated by the first function, wherein
the parameter is represented by a coordinate value on a positioning map including at least a first coordinate axis and a second coordinate axis, and
the first function updates a component of the parameter on the first coordinate axis based on a first element and a second element among the three elements, and updates a component of the parameter on the second coordinate axis based on the first element and a third element among the three elements.

20. The non-transitory computer-readable recording medium according to claim 19, wherein the device is a robot simulating a living creature.
